(19) United States
(12) Patent Application Publication
(10) Pub. No.: US 2014/0338613 A1
(43) Pub. Date: Nov. 20, 2014

(54) Rolling Ball Pet Toy

(71) Applicant: Pioneer Pet Products, LLC, Cedarburg, WI (US)

(72) Inventors: Stanley L. Suring, Cedarburg, WI (US); John M. Lipscomb, Cedarburg, WI (US)

(21) Appl. No.: 14/370,116

(22) PCT Filed: Jan. 11, 2013
(86) PCT No.: PCT/US2013/000014

§ 371 Date: Jul. 1, 2014

Related U.S. Application Data
(60) Provisional application No. 61/585,645, filed on Jan. 11, 2012.

(51) Int. Cl. A01K 15/02

(52) U.S. Cl. CPC A01K 15/025
USPC 119/707

(57) ABSTRACT

A pet toy having a track with an attractant or lure that preferably is a ball that rolls around the track when a rocker arm is rotated by a rotary drive. An animal proximity sensor that includes a switch energizes, de-energizes and/or reverses direction of the drive when actuated by a pet. The arm carries a counterweight and is supported by bearing that rides on a base of the toy spacing the arm so it clears an onboard power supply. A preferred toy has a fulcrum resting on a support surface about which the track rocks during arm rotation and can include a rib that provides rotating point or line contact with the surface during rotation. An acoustic resonator recess, e.g. channel, formed in the track amplifies the sound of a ball rolling in the track producing a distinctive sound that attracts pets, e.g., cats, and is pleasing to humans.

### FIELD

The present invention relates generally to pet toys and more particularly to seek and chase toys employing a moving attractant, such as a ball, mouse or the like, that is particularly attractive to cats.

### BACKGROUND

Many cat toys have been marketed including several which employ balls that roll including during cat interaction. One such cat toy disclosed in U.S. Pat. No. 5,544,623 has a base with a bottom that includes a fulcrum that rests directly on the floor and rocks or tips about the fulcrum when a motor carried by the base rotates a weighted arm causing a ball in a channel in the base to roll around. Unfortunately, the motor is powered by a cord with a coupling connected to a transformer that plugs into a wall outlet that can become uncoupled during cat interaction with the toy. In addition, because the motor constantly runs when the cord is plugged into the outlet, a cat playing with the toy will quickly become tired or habituated.

What is needed is such a pet toy that overcomes these disadvantages which operates in a manner that reduces habituation.

### SUMMARY

The present invention is directed to a pet entertainment device that is a pet toy that includes a track in which one or more attractants or lures are movably received that each preferably is a ball that rolls around in the track during use and operation of the toy. The track preferably is annular and is carried by a base of a housing of the toy with the base having a fulcrum extending from its bottom that rests on a support surface, e.g. ground or floor, with the track rocking or teetering about the fulcrum causing each ball in the track to move around the track during use and operation of the toy. A downwardly extending bottom rib spaced outwardly of the fulcrum provides a moving point or line contact land with the support surface that helps minimize friction and energy usage during rocking or teetering of the track.

The toy includes a prime mover that preferably is a rotary drive that rotates a rocker arm carrying a counterweight disposed adjacent the track to cause the track to rotatively rock or teeter in concert with the arm. The rotary drive includes an electric motor electrically connected to a power supply carried by a housing of the toy within the housing. The counterweight is carried by a counterweight carriage disposed at or adjacent a radially outer end of the arm that is supported on a guide that includes a bearing that rides on part of the bottom of the base spacing the arm above the power supply so the arm clears the power supply during arm rotation while also reducing friction and motor power consumption. In a preferred embodiment, the power supply is a self-contained onboard power supply that includes a battery compartment covered by a removable cover that holds a plurality of replaceable or rechargeable batteries that can be of disposable construction.

The power supply and rotary drive are received in a rotary drive chamber with a bottom of the chamber formed of part of the base of the toy that can include a platter that can be disengaged and detached to access the rotary drive and/or power supply. Where equipped with a removable or detachable platter, the platter can include a plurality of spaced apart finger or thumb holes formed therein enabling the platter to be manually grasped and rotated relative to the rest of the housing of the toy to disengage the platter.

The toy can include a proximity sensor configured to energize, de-energize and/or switch the rotational direction of the motor and rocker arm when a pet, such as preferably a cat, moves into close proximity to the toy. In a preferred embodiment, the sensor is or includes a switch that energizes, de-energizes and/or switches the rotational direction of the motor and arm when a pet interacts with the toy in a manner that actuates the switch. Such an arrangement can be configured to cause the motor to dwell or pause before switching the direction of rotation of the rocker arm to cause the direction of ball movement to transition from one direction to an opposite direction helping to maintain and even heighten pet interaction.

The housing of the toy can include a top which overlies the motor, arm and battery compartment defining a top portion of the rotary drive chamber overlying the bottom of the chamber. Any switch of the proximity sensor can be carried by the top of the housing with the top being disposed radially inwardly of the track and configurable to accommodate one or more animal attractants, such as a cat scratcher and/or elongate wand plaything. The housing top can include or form a platform that can be generally flat or planar upon which an attractant, such as a cat scratcher can be removably mounted. Such a platform can also be configured to accommodate another attractant, such as the elongate wand plaything, with a wand of the plaything anchored to the platform.

Where equipped with a proximity sensor that includes a switch, the switch can cooperate with a switch actuator carried by or otherwise formed of part of an animal attractant carried by or mounted to the platform. Such a switch can be a depressible pushbutton switch, a limit switch, a proximity switch, a reed switch, a rotary switch, a joystick switch or the like. Such a switch can be configured to actuate when a pet rests or steps on part of the platform and/or engages an animal attractant, e.g. elongate wand plaything, carried by or mounted to the platform.

In a preferred embodiment, the recessed track is formed of a generally U-shaped track sidewall that includes an acoustic resonator recess formed therein that can be in the form of an elongate channel formed in part of the track sidewall. One preferred track sidewall construction has a generally rounded concave track bottom in which the acoustic resonator recess is formed and a pair of spaced apart generally upwardly extending track sides. One track side can define an outer sidewall of the toy and the other track side can bound or encircle the platform. If desired, a portion of the other track side can extend upwardly beyond the top of the housing defining a lip of the platform that bounds and helps locate any animal attractant, such as a cat scratcher, mounted on or to the platform.

Where equipped with an acoustic resonator recess, the ball preferably is a solid ball that can be of plastic construction cooperating with the track and recess to form an acoustic transducer that produces a desirably pleasing sound emanating from the track that includes one or more white noise or pink noise components when the ball rolls around the track and which can sound like the ocean surface. Where equipped with such an acoustic resonator recess, the unique sound produced by a ball rolling around in the chamber helps not only attract an animal and/or help keep the animal interacting with the toy but also is pleasant and soothing to humans. Where equipped with an acoustic resonator recess that is a channel, the channel can also help guide a ball rolling around in the channel and can help form or define part of the rib.

In another preferred toy embodiment, one of the ball or counterweight is or includes a magnet or is of magnetically attractive construction and the other one of the ball or counterweight is or includes a magnet or is of magnetically attractive construction. Such a configuration will cause the ball to follow the rotating rocker arm as the ball rolls in the track causing the ball to orbit about the track substantially in unison with rotation of the rocker arm.

These and various other features, aspects, and advantages of the present invention will be made apparent from the following descriptions of the drawings.

### DRAWING DESCRIPTION

The drawings illustrate one or more preferred embodiments presently contemplated for carrying out the invention. In the drawings:

FIG. 1 is a perspective view of a pet, i.e., cat, interacting with a pet entertainment device constructed in accordance with the present invention that is a pet toy well suited for cats.

FIG. 2 is an enlarged top perspective view of the pet toy illustrating a top platform upon which a pet can step, climb or otherwise engage that can include or carry one or more pet interactive arrangements.

FIG. 3 is an elevation view of the pet toy with a portion of the housing of the toy cutaway to show a pet operable switch in more detail.

FIG. 4 is a top plan view of the pet toy with a movable attractant or lure received in its track.

FIG. 5 is a generally transverse or vertical cross-sectional view of the pet toy.

FIG. 6 is an elevation view of the pet toy with a portion of its housing cutaway depicting rotary movement of an arm that causes an attractant or lure to move in its track and which can be operably coupled to a generally upwardly extending plaything to substantially simultaneously move the plaything.

FIG. 7 is an enlarged fragmentary transverse or vertical cross-sectional view of the track of the pet toy in which an attractant or lure that is at least one ball is removably received and which is movable in the track relative to the housing of the toy.

FIG. 8 is a generally horizontal cross-sectional top plan view of the pet toy with its platform removed illustrating a chamber formed by a base of the toy and the platform in which a motor and battery compartment are located.

FIG. 9 is a bottom plan view of the pet toy illustrating a motor and battery compartment carrying platter that is removably attached to a base of the toy.

FIG. 10 is a top perspective view of the motor and battery compartment carrying platter after it detachment from the base of the housing of the pet toy.

FIG. 11 is a bottom perspective view of the detached motor and battery compartment carried by a platter with a battery cover and batteries shown exploded from the battery compartment.

FIG. 12 illustrates another preferred embodiment of a pet entertainment toy constructed in accordance with the present invention where one of the arm and attractant/lure is magnetic or includes a magnet and the other one of the arm and attractant/lure is made of a magnetically attractable material or includes something magnetically attractable.

Before explaining embodiments of the invention in detail, it is to be understood that the invention is not limited in its application to the details of construction and the arrangement of the components set forth in the following description and illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION

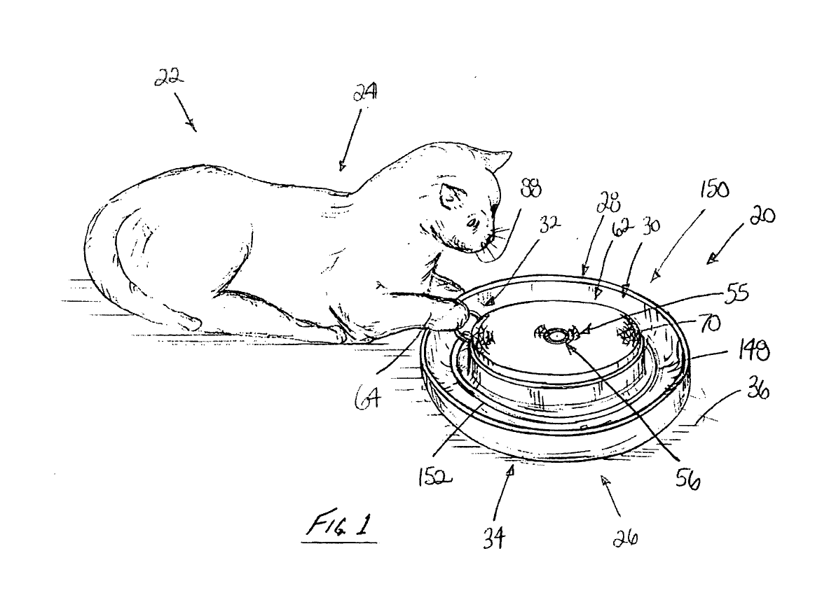

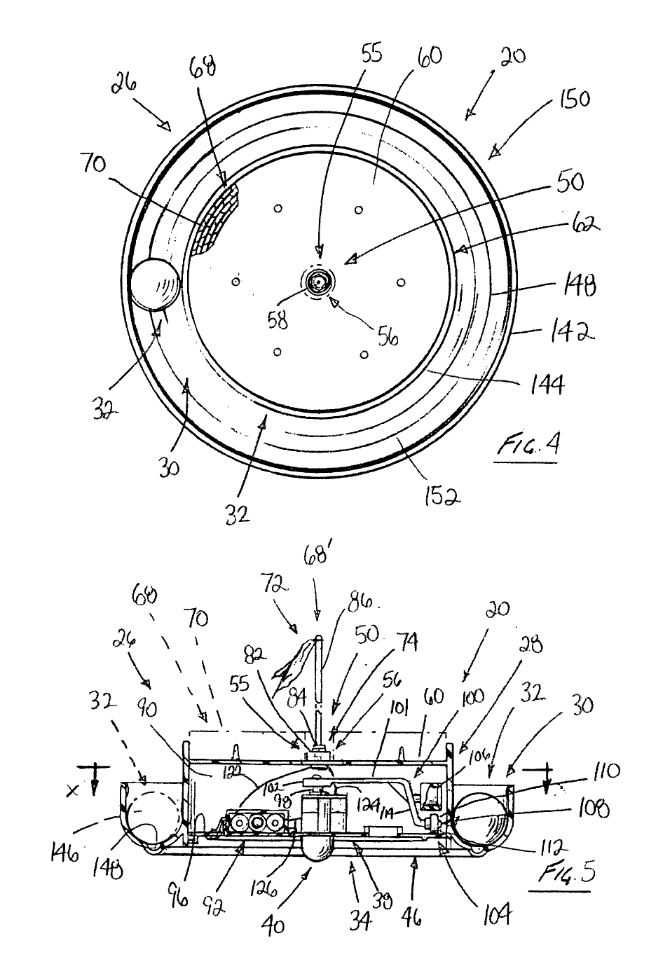

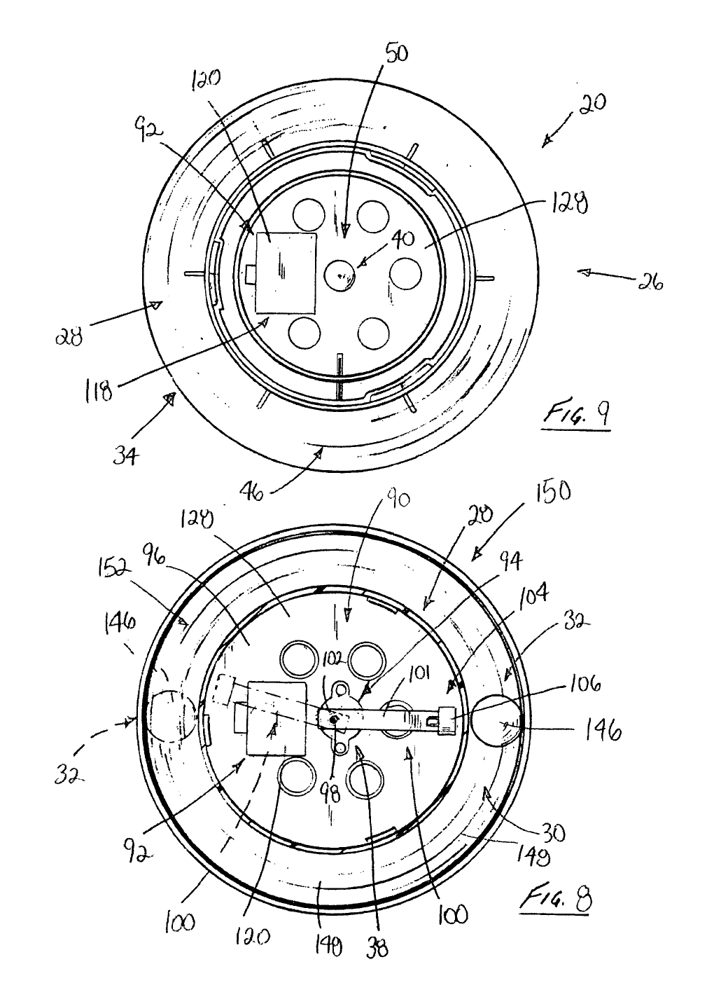

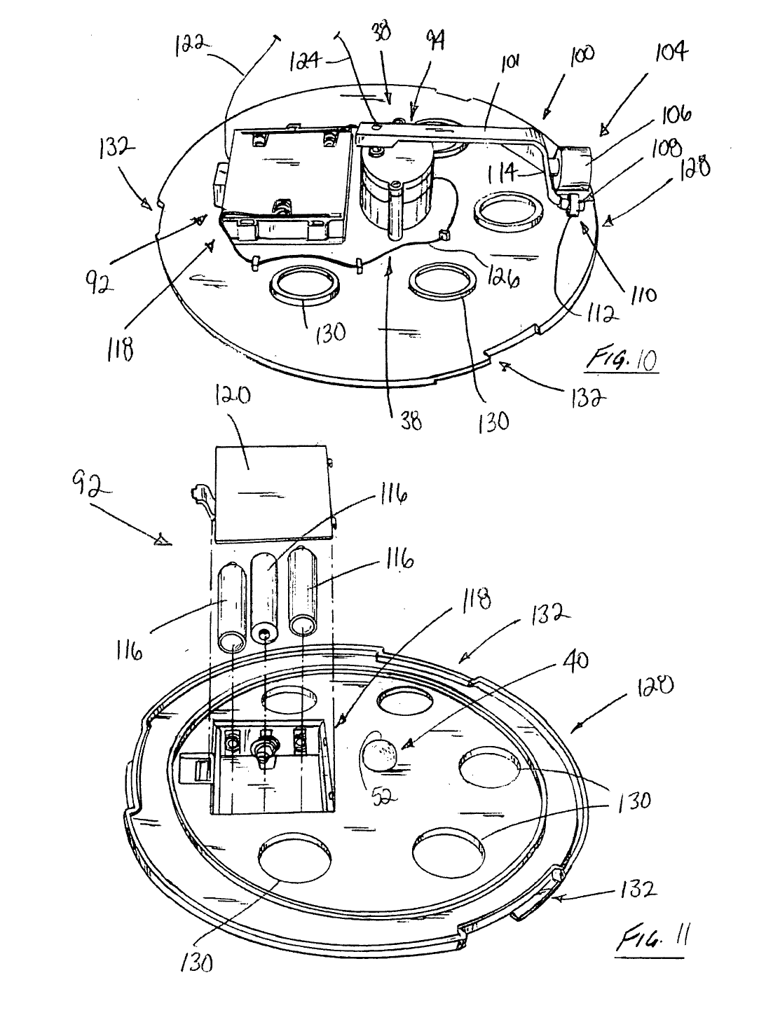

FIGS. 1-11 illustrate a preferred embodiment of a pet entertainment device that is a pet toy 20 constructed in accordance with the present invention that is configured to attract the attention of a pet 22, preferably a cat 24, such as depicted in FIG. 1, such that at least one preferred embodiment of the toy 20 is a cat toy 26. The toy 20 includes a housing 28, a recessed track 30 in which at least one attractant or lure 32 is received, and a base 34 that rests on a generally flat or planar support surface 36, such as the ground, the floor, a table or the like. As is best shown in FIGS. 5, 6, 8 and 10, the base 34 carries a rotary drive 38 that can be and preferably is disposed within the housing 28 that causes the attractant or lure 32 to move within the track 30 relative to the track 30 during rotary drive operation.

In the preferred pet entertainment toy embodiment shown in FIGS. 1-11, the base 32 includes a fulcrum 40 that extends outwardly from a bottom 42 of the base 34 contacting the support surface 36 defining a pivot 44 about which the track 30 rocks or teeters during rotary drive operation. The base 34 also includes a rib 46 spaced from the fulcrum 40 that also extends outwardly from the bottom 42 of the base 34 with that portion of the rib 46 contacting the support surface 36 functioning as a land 48 that also helps support the toy 20 on the support surface 36.

In the preferred pet entertainment toy embodiment shown in FIGS. 1-11, the track 30 can be curved and can be formed of one or more curved sections or segments. As is best shown in FIGS. 1, 2, 4 and 9, the track 30 of the preferred toy embodiment is a ring-shaped track 30 that is annular or circular with the fulcrum 40 being generally centrally located relative to a track center 50 encircled by the track 30. In a preferred embodiment, the fulcrum 40 can be substantially centrally located relative to the center 50 of the track 30 such that the fulcrum 40 can be substantially coincident with the track center 50 and/or substantially coaxial with a generally vertically extending central axis (not shown) extending through the center 50 of the track 30.

The rocker support rib 46 can also include or be formed of one or more curved sections or segments and can be continuous or substantially continuous extending about the fulcrum 40 preferably encircling the fulcrum 40 and being radially outwardly spaced from the fulcrum 40. In the preferred pet entertainment toy embodiment shown in FIGS. 1-11, the rib 46 is also ring-shaped, annular or circular with the rib 46 spaced radially outwardly of the generally centrally located fulcrum 40. As is best shown in FIGS. 3, 5 and 7, both the fulcrum 40 and rib 46 are curved having a curved or rounded transverse cross-sectional contour that facilitates rocking or teetering of the track 30 during operation of the rotary drive 38. In this regard, the fulcrum 40 can be substantially hemispherical or have a substantially hemispherical support surface contacting end 52, such as depicted in FIG. 5, and the rib 46 can also have a substantially hemispherical transverse cross-section or a substantially hemispherical support surface contacting end 54, such as also depicted in FIG. 5.

Such a configuration advantageously produces point contact between the fulcrum 40 and the support surface 36 and produces point or line contact between the land 48 of the rib 46 and the support surface 32 thereby minimizing friction therebetween producing more efficient teetering or rocking during rotary drive operation. By minimizing the surface area of contact between the toy 20 and support surface 36, electrical power consumption is reduced and preferably minimized. By using a rounded or curved fulcrum 40 and rib 46, contact surface area with the support surface 36 is not only minimized but it enables the toy 20 to rock and teeter on support surfaces 36 that may not be perfectly smooth or which have small debris or particulate matter thereon that underlies part of the toy 20. Finally, such an arrangement advantageously also helps produce more efficient movement of the attractant or lure 32 within the track 30.

Where the rotary drive 38 is configured for bi-directional rotation, such a curved or rounded fulcrum 40 and curved or rounded rib 46 makes transitions between clockwise and counterclockwise (and vice versa) rotary drive motion smoother, quicker and with a minimum of power consumption. In addition, such a configuration helps impart a desired randomness of attractant or lure movement within the track 30 during a transition helping to attract a pet 22, e.g. a cat 24, into interacting with the toy 20 such as by interacting or trying to interact with the attractant or lure 32. During such a transition, deceleration of the lure or attractant 32 within the track 30 can be and preferably is relatively rapid or sudden before the lure or attractant 32 stops and begins moving in an opposite direction in the track 30. When the lure or attractant 32 begins moving in the opposite direction during such a transition, the lure or attractant 32 rapidly accelerates in the track 30 before its velocity becomes more constant or relatively constant. Such rapid deceleration when moving in one direction once such a transition begins and the following rapid acceleration that occurs after beginning to move in an opposite direction produces a relatively random lure or attractant motion to a pet 22, particularly a cat 24, which helps prevent habituation thereby spurring extended interaction and play with the toy 20 by the pet 22.

As is also shown in FIGS. 3, 5 and 7, the rib 46 extends axially outwardly from a generally flat or planar bottom 42 of the base 32 a first distance and the fulcrum 40 extends axially outwardly from the bottom 42 a second distance that is greater than the first distance of the rib 46. In one preferred embodiment, the fulcrum 40 extends outwardly from the bottom 42 a second distance that is at least fifty percent greater or farther than the first distance that the rib 46 extends outwardly from the bottom 42. In another preferred embodiment, the fulcrum 40 extends outwardly from the bottom 42 a second distance that is at least one hundred percent greater or farther than the first distance that the rib 46 extends outwardly from the bottom 42.

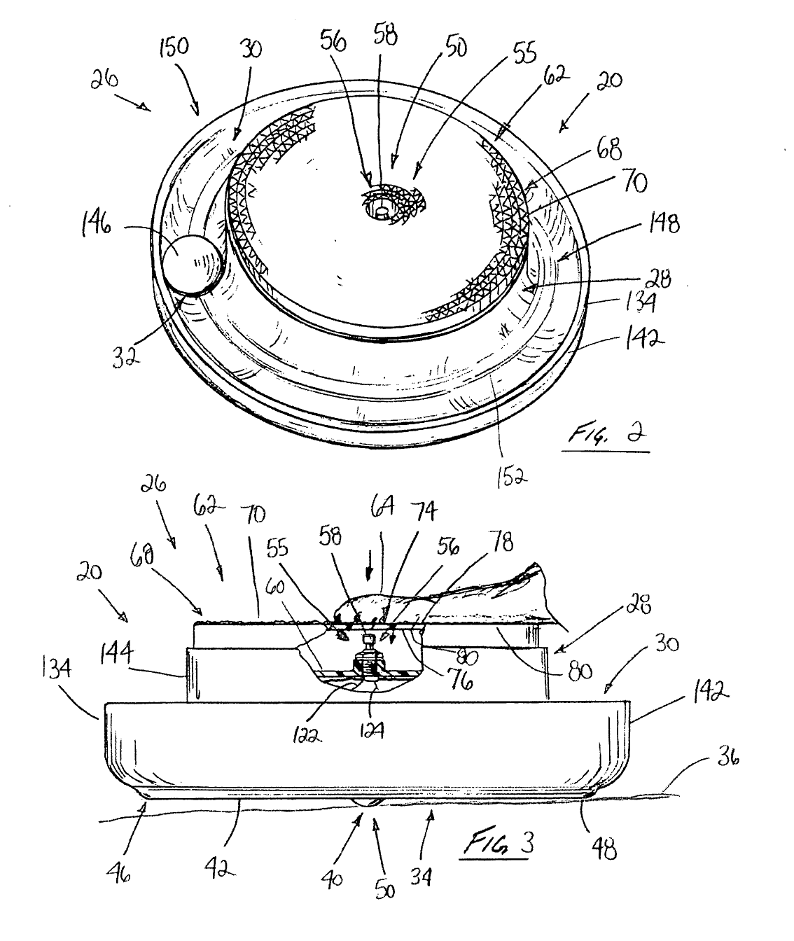

In the preferred pet entertainment toy embodiment shown in FIGS. 1-11, the track 30 can be and preferably is integrally formed in and of part of the housing 28 of the toy 20 with the housing 28 carrying a proximity sensor 55 that can be or include a pet operable switch 56 that energizes the rotary drive 38 causing the drive 38 to operate when the switch 56 is actuated by a pet 22 in close proximity to the toy and/or which interacts with the toy 20. In this regard, where a proximity sensor 55 is employed that uses a switch 56, the switch 56 can be a contact switch, such as a depressible pushbutton switch 58, which is attached or otherwise fixed to part of the housing 28 disposed adjacent the track 30, such as the pushbutton switch 58 shown most clearly in FIGS. 2 and 3 disposed inboard of the track 30. As is also depicted by FIGS. 2 and 3, such a switch 56, e.g., pushbutton switch 58 can be generally centrally located at or near track center 50.

In the preferred pet entertainment toy embodiment shown in FIGS. 1-11, the housing 28 includes a top 60 that carries the switch 56 with the switch 56 configured to actuate when a pet 22 interacts with the toy 20 at or near the vicinity of the switch 56. The top 60 is located inboard of the track 30 such that the track 30 bounds, encompasses or encircles the top 60. The top 60 can define a platform 62 upon which at least part of the pet 22, such as one or more paws 64 of the pet 22 can contact, rest, or even engage during interaction with the toy 20.

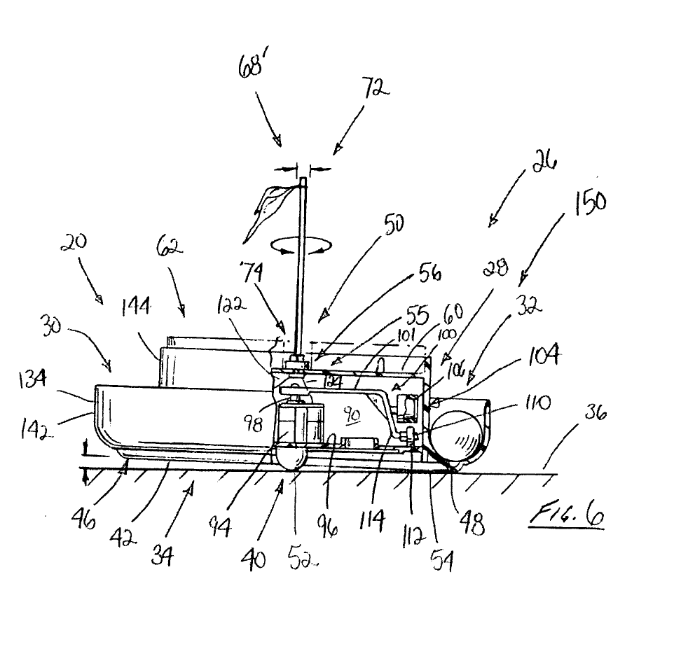

The platform 62 can be configured to operably cooperate with the switch 56 in a manner such that contact with the platform 62 by a pet 22 interacting with any part of the platform 62 actuates the switch 56 energizing the rotary drive 38. Such a platform 62 can be generally flat or substantially planar, such as depicted in FIGS. 1-6, and can be configured to include or function as a receptacle or holder 66 used to hold another attractant 68, such as a cat scratcher 70, such as depicted in FIGS. 1 and 2, and/or a generally upwardly extending animal plaything 72, such as depicted in FIGS. 5 and 6.

The sensor 55 can be exposed, such as where the switch 56 is exposed as shown in FIG. 2, enabling the pet 22 to directly contact the switch 56 during interaction with the toy 20 to actuate the switch 56. The sensor 55 can also or instead include an actuator 74 in operable cooperation with the switch 56 that actuates the switch 56 when part of the pet 22 contacts the actuator 74. Such a switch actuator 74 can be located adjacent the switch 56, such as shown in FIG. 3, and can overlie, be connected to, and/or otherwise be coupled to or with the switch 56 in a manner that causes pet interaction with or in the vicinity of the actuator 74 to actuate the switch 56.

With specific reference to FIG. 3, the actuator 74 can be a depressible switch actuator 76 that overlies the switch 56 that displaces downwardly when a pet 22 contacts the actuator 76 actuating the switch 56 when sufficient displacement has occurred. While the depressible actuator 76 can be disposed in direct contact with the switch 56, it can also be spaced from the switch 56 by a gap that ensures that the switch 56 will not actuate until a sufficient amount of deflection or displacement of the depressible actuator 76 has occurred.

In the embodiment of the depressible actuator 76 shown in FIG. 3, the depressible actuator 76 can be formed of or from a plate or panel 78 that can be generally flat or substantially planar where at least a portion of the actuator plate or actuator panel 78 is located in close enough proximity to the switch 56 that sufficient deflection or displacement of the actuator plate or actuator panel 78 will actuate the switch 56. Such an actuator plate or actuator panel 68 can be formed of a layer or sheet of cardboard, a panel or board made of plastic, particle board and/or fiber board, or formed of a plate of metal, plastic, glass or the like. Such an actuator plate or actuator panel 78 can be carried by, attached to, form part of or be formed of an attractant 68 that is carried by the housing 28 of the toy 20. In this regard, where the attractant 68 is a cat scratcher panel 80 formed of cardboard, the depressible actuator plate or panel 78 can be integrally formed of the cardboard cat scratcher panel 80 overlying the switch 56 such as in the manner depicted in FIG. 3 such that a cat 24 scratching the cat scratcher panel 80 can cause part of the panel 80 overlying the switch 56 to deflect or displace toward the switch 56 actuating the switch 56.

Where the toy 20 employs a depressible actuator 76, the switch 56 can be a depressible push button switch 58, such as the depressible pushbutton switch 58 shown in FIG. 3. If desired, another type of a switch, such as a limit switch, a membrane switch, a proximity switch that can be magnetically actuated, a reed switch, or a switch that includes or employs a Hall effect sensor, can be used instead of or in addition to a depressible push button switch 58.

With reference to FIGS. 5 and 6, the actuator 74 can be a motion sensing actuator 82 in operable cooperation with an animal plaything 72 that extends upwardly from the top 60 of the housing 28 of the toy 20 that senses movement in close proximity to the actuator 82 and actuates the switch 56 in response to such movement. In the pet entertainment toy embodiment shown in FIGS. 5 and 6, the motion sensing actuator 82 can be operatively connected to or formed from or of part of a stem 84 from which an elongate wand 86 of the plaything 72 upwardly extends with the stem 84 used to attach or otherwise anchor the plaything 72 to the top 60 of the housing 28.

Although not clearly shown, in one embodiment, the motion sensing actuator 82 is formed of part of the wand 86 of the plaything 72 that is configured to actuate the switch 56, such as by contacting or engaging the switch 56, when any part of the plaything 72 is displaced far enough. In such an embodiment, the motion sensing actuator 82 is configured to actuate the switch 56 when a pet 22, preferably a cat 24, interacts with the plaything 72, such as by batting the plaything 72 around using one of its paws 64 and/or by grasping and pulling part of the plaything 72 with its mouth 88.

Where a proximity sensor 55 with a motion sensing actuator 82 is employed that actuates a switch 56 in response to animal motion or animal initiated motion of an attractant 68′, e.g., animal plaything 72, the switch 56 can also be a depressible pushbutton switch, e.g. pushbutton switch 58, but can also be a limit switch, a proximity switch that can be magnetically actuated, a reed switch, a membrane switch, a mercury switch, a switch including or employing a Hall effect sensor, a rotary switch or a joystick switch.

The top 60 of the housing 28 overlies a portion of the bottom 42 of the base 34 defining a rotary drive chamber 90 that substantially encloses the rotary drive 38 along with at least a portion of a power source or supply 92 shielding both from a pet 22 interacting with the toy 20. The rotary drive 38 includes a motor 94 that preferably is electrically powered that is fixed to an interior surface 96 of the bottom 42 of the base 34, such as by one or more fasteners or the like. As is best shown in FIGS. 5, 6, and 10, the motor 94 can be generally centrally located having a generally vertically extending rotary output shaft 98 that can be generally coincident with the track center 50 or generally coaxial with a generally vertically extending central axis 51 if desired.

The motor output shaft 98 carries a rocker arm 100 that can be elongate and which extends radially outwardly from the motor 94 toward the track 30, such as in the manner depicted in FIG. 5. The rocker arm 100 include a hub or mount 102 at one end that is configured to enable the arm 100 to be attached or otherwise fixed to the motor output shaft 98 in a manner where the output shaft 98 and arm 100 rotate substantially in unison. The rocker arm 100 also includes a radial arm segment 101 extending radially outwardly from the hub or mount 102 to a counterweight carriage 104 disposed at or adjacent an opposite end of the arm 100. The counterweight carriage 104 carries a counterweight 106 and can include a guide 108 that rides along the interior surface 96 of the bottom 42 of the base 34 of the toy 20 supporting the weight of the counterweight 106 thereon.

In a preferred embodiment, the counterweight carriage 104 orbits about the motor output shaft 98 alongside but radially inboard of the track 30 during rotary drive operation. At least a portion of the counterweight 106 overlies the guide 108 that rides on the interior surface 96 of the bottom 42 of the base 34 when the rocker arm 100 is rotated by the rotary drive motor 94 during operation. In a preferred embodiment, the guide 108 is formed of or includes a bearing 110 having at least a portion of the bearing 110 in contact with the interior surface 96 of the bottom 42 of the base 34. One preferred bearing embodiment is or includes a wheel or roller 112 that can be a roller 112 of a roller bearing that rotatively rides in contact with the interior surface 96 of the bottom 42 of the base 34 along the interior surface 96 of the bottom 42 of the base 34 when the arm 100 is rotated by the motor 94.

The guide 108 advantageously functions as a support that transfers the weight of the counterweight 106 to the base 34 of the toy 20 thereby helping to more smoothly and efficiently cause the track 30 to rock or teeter about the generally central fulcrum 40 producing a clockwise or counterclockwise rotary rocking or teetering motion depending on the direction of rotation of the rocker arm 100. Where the guide 108 includes a bearing 110, the use of such a bearing 110 helps minimize rotary drive motor energy consumption. The guide 108 can also serve as a spacer configured to space the radial segment 101 of the rocker arm 100 sufficiently far enough above the interior surface 96 of the bottom 42 of the base 34 that the arm 100 clears any portion of the power supply 92 disposed onboard the toy 20 that extends inwardly into the rotary drive chamber 90. As best shown in FIGS. 5 and 6, a generally axially extending leg 114 can extend generally downwardly from the radial arm segment 101 to the guide 108 and can form part of the guide 108 spacing the radial arm segment 101 sufficiently high enough above the interior surface 96 of the bottom 42 of the base 34 that the arm segment 101 will clear the power supply 92 during rocker arm rotation.

The power supply 92 can be and preferably is a self-contained power supply located onboard the toy 20 that can be substantially completely disposed within the rotary drive chamber 90 such as is depicted in FIGS. 5 and 8-10. In a preferred embodiment, the power supply 92 includes a plurality of replaceable or rechargeable batteries 116 received in a battery compartment 118 formed in and/or of the base 34 that can include a cover 120 to enable removal and replacement or recharging of the batteries 116. Where batteries 116 are used as the power supply 92 that powers the rotary drive motor 94, the batteries 116 can be AA batteries, AAA batteries, C-cell batteries, D-cell batteries or the like.

The rotary drive motor 94, power supply 92 along with any electrical components of any proximity sensor 55 employed are electrically connective via an electrical circuit 120 that can be a series circuit or include a series circuit branch electrically connecting the power supply 92 to the sensor 55, such as by being connected to any switch 56 of or employed by the sensor 55, electrically connecting the sensor 55 to the motor 94, and electrically connecting the motor 94 to the power supply 92. With reference to FIGS. 5 and 10, such a circuit can include or be formed of electrical wires with one wire 122 connecting the power supply 92 to the proximity sensor 55, such as by being connected to a switch 56 of the sensor 55, a second wire 124 connecting the sensor 55 to the rotary drive motor 94, and a third wire 126 connecting the motor 94 to the power supply 92.

Of course, other wiring configurations are contemplated. Where the toy 20 includes an onboard circuit board (not shown) or other electrical components (not shown), such as a FPGA, microcontroller, microprocessor, firmware and/or the like (and which can also or instead be disposed onboard the motor 100), the circuitry and/or wiring can be modified to incorporate such a circuit board and/or one or more of such electrical components. Such components and/or circuit board can be used to receive and/or interpret signals from any proximity sensor 55 and/or any switch 56 thereof to cause the motor 94 to be energized upon actuation of sensor 55 and/or switch 56, cause the direction of rotation of the motor 94 to be reversed upon sensor/switch actuation, cause the motor 94 to dwell or pause upon sensor/switch actuation, and/or carry out some other function in conjunction therewith upon sensor/switch actuation instead of simply starting or stopping the motor 94 upon actuation of sensor 55 and/or switch 56.

The rotary drive motor 94 and power supply 92 can be carried by part of the base 34 that is or includes a removable platter 128 that rotatively engages another part of the base 34 that is or integrally forms at least a portion of the housing 28 of the toy 20 to removably attach the platter 128 to the rest of the base 34. Such a removable or twist-off platter 128 enables the motor 94, power supply 92, rocker arm 92, etc. disposed within the rotary drive chamber 90 to be accessed, such as for cleaning any of these components, the chamber 90, etc.

The generally round platter 128 can include a plurality of access openings 130 that function as finger and/or thumb holes through which one or more digits of a hand of a person engaging the platter 128 are inserted. Once inserted, the platter 128 is manually twisted to disengage and remove the platter 128. The platter 128 has a plurality of circumferentially spaced apart notched wedges 132 formed in its outer periphery that frictionally wedge with or against and engage complementary notched wedges formed in the fixed portion of the base 34.

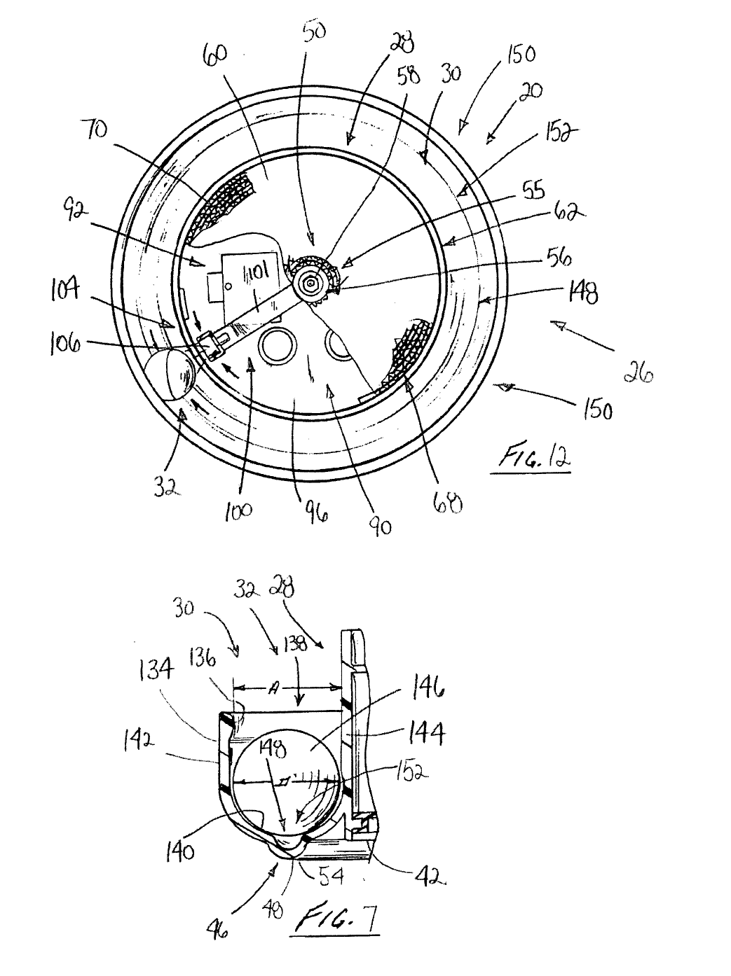

FIG. 7 illustrates the cross-sectional configuration of the track 30, which is recessed and generally U-shaped. The annular track 30 is formed by a generally U-shaped track sidewall 134 that can include an inwardly extending lip 136 that reduces the width of a mouth 138 of the track 30 so it is less than the width or diameter of the attractant or lure 32 received in the track 30 helping to oppose its removal from the track 30. The track sidewall 134 is formed of a generally concave rounded or curved track bottom 140 from which a pair of spaced apart track sides 142 and 144 generally upwardly extends.

In a preferred pet entertainment toy embodiment, there is at least one attractant or lure 32 received in the track 30 as the present invention contemplates a plurality of spaced apart attractants or lures 32 received in the track 30 that can each be movable in the track 30 relative to the track 30 and relative to one another during toy operation. In a preferred embodiment, each attractant or lure 32 is or includes a round ball 146 that rolls around within the track 30 when the motor 94 rotates the rocker arm 100 causing the track 30 to rock or teeter in a rotating circular pattern.

With continued reference to FIG. 7, the rib 46 generally underlies the track 30 extending outwardly downwardly in a direction opposite the track 30. Such a rib 46 provides a point or line contact land 48 whose portion of the rib 46 adjacent the counterweight carriage 104 contacts the underlying support surface 36 upon which the toy 20 rests during rotary drive operation. Such a rib 46 advantageously helps strengthen, structurally rigidifies, and/or stiffens the housing 28.

As is also shown by FIG. 7, the track bottom 140 can and preferably does include a recessed ball guide channel 148 formed therein that helps guide each ball 146 received in the track 30. The channel 148 has a circular cross-section and is generally U-shaped extending substantially continuously about the entire track 30 forming or helping to form the rib 46 that extends downwardly from the track 30. The channel 148 also works synergistically with the track 30 acoustically coupling and/or reducing acoustic impedance of the track 30 such that each ball 146 rolling around the track 30 during rotary drive operation produces a sound that is acoustically amplified and directed from the track 30 helping to attract a pet 22 into interacting with the toy 20. The rolling ball(s) 146, track 30 and channel 148 collectively form a transducer 150 that amplifies the sound of the ball(s) 146 rolling around in the track 30 producing a sound that is at least five decibels louder than a track 30 lacking such a channel 148. Such a channel 148 therefore not only can help function as a ball guide but also advantageously functions as an acoustic resonator recess 152 that is an acoustic resonator that helps amplify sound produced by the ball(s) 146 rolling around in the track 30 before the bottom 140 and sides 142, 144 of the track 30 direct the amplified sound from the track 30. In another preferred embodiment, the arrangement advantageously amplifies the sound emitted from the track 30 producing a sound that is at least seven decibels louder. In still another preferred embodiment, the arrangement advantageously amplifies the sound emitted from the track 30 producing a sound that is at least ten decibels louder.

In a preferred embodiment, each ball 146 is made of plastic and preferably is solid such that a ball 146 of solid plastic construction rolling around a track 30 equipped with an acoustic resonator channel 148 produces a sound that can be or include white and/or pink noise components and which can sound like ocean waves or surf. Such a unique sound not only helps attract and maintain the interest of a pet, but the sound produced is advantageously soothing and pleasant to humans. Where each ball 146 is made of plastic, it can be made of polypropylene, polyethylene, polyurethane, nylon, acetate, acrylic, acetal, polyacetal, a thermoplastic polymer. One preferred solid plastic ball 146 well suited for use with a toy 20 constructed in accordance with the invention is a foosball ball.

In another preferred embodiment, each ball 146 is hollow and made of plastic, such as one of the plastics discussed above in the preceding paragraph. One preferred hollow plastic ball 146 well suited for use with a toy 20 constructed in accordance with the invention is a ping pong ball or table tennis ball.

FIG. 12 illustrates another preferred embodiment of a pet entertainment toy 20 constructed in accordance with the present invention where one of the counterweight carriage and ball 146 is magnetic and the other one of the counterweight carriage and ball 146 is made of a magnetically attractive material. In one embodiment, the ball 146 is made of or includes a metal or metallic material, such as steel or the like, which is magnetically attractive and the counterweight carriage includes or otherwise carries a magnet. Where the counterweight carriage includes or otherwise carries a magnet, the counterweight, part of the bearing, and/or an adjacent part of the rocker arm can be magnetic or otherwise be formed of a magnet. In another embodiment, the ball is magnetic and the counterweight made of or which otherwise includes or carries a magnetically attractive material, such as steel or the like. Such a ball can be metallic, made of metal, and can be hollow.

During operation of such a toy 20′, rotation of the rocker arm causes the ball to follow the arm whether or not the base is equipped with a fulcrum and/or rib. In a preferred embodiment, even where lacking a fulcrum and/or rib, the track in which the ball rides includes acoustic resonator channel.

Understandably, the present invention has been described above in terms of one or more preferred embodiments disclosed herein. It is therefore recognized that various alternatives and modifications may be made to these embodiments which will remain within the scope of the appended claims.

What is claimed is:

1. A pet entertainment toy comprised of a base comprising a track that receives at least one ball movable in the track relative to the base.

2. The pet entertainment toy of claim 1 wherein the track further comprises a acoustic resonator channel formed therein that amplifies the sound of the ball rolling around in the channel.

3. The pet entertainment toy of claim 2 wherein the track, acoustic resonator channel and ball comprises an acoustic transducer.

4. The pet entertainment toy of claim 3 wherein the track is formed of a track wall and has a generally U-shaped cross-section and wherein the acoustic resonator channel is formed in the track wall.

5. The pet entertainment toy of claim 1 further comprising a motor in operable cooperation with the base that causes the at least one ball to move in the track and further comprising a switch carried by the base actuated by a pet interacting with the pet entertainment device controlling motor operation.

6. The pet entertainment toy of claim 5 wherein the base comprises a fulcrum in contact with a support surface below the base about which the base and track rocks when the motor operates and wherein the base comprises a platform in operable cooperation with the switch that actuates the switch when a pet contacts the platform energizing the motor.

7. The pet entertainment toy of claim 5 wherein the base comprises a fulcrum in contact with a support surface below the base about which the base and track rocks when the motor operates and wherein the base comprises a generally upwardly extending animal plaything in operable cooperation with the switch that actuates the switch when a pet contacts the animal plaything energizing the motor.

8. The pet entertainment toy of claim 1 further comprising a motor in operable cooperation with the base having a rotary output shaft from which an elongate arm generally radially extends that carries a counterweight and a roller that rides on the base when the arm is rotated causing the at least one ball to move in the track.

9. The pet entertainment toy of claim 8 wherein one of the at least one ball and the arm comprise a magnet and the other one of the at least one ball and the arm are comprised of a magnetically attractable material.

10. The pet entertainment toy of claim 8 wherein the counterweight overlies the roller.

11. The pet entertainment toy of claim 8 wherein the base comprises a battery holding compartment and wherein the arm has a generally radially outwardly extending segment and a generally downwardly extending segment carrying the roller spacing the generally radially outwardly extending segment above the base so the generally radially outwardly extending segment clears the battery holding compartment.

12. The cat toy of claim 9 wherein the rotary arm is spring biased against the track floor pivoting the track relative to the base during rotation of the rotary arm.

13. The cat toy of claim 12 wherein the rotary arm comprises an elongate spring in contact with the track floor during rotation of the rotary arm.

14. The cat toy of claim 9 wherein the rotary arm comprises a bearing in rotative contact with the track floor during rotation of the rotary arm.

15. The cat toy of claim 14 wherein the bearing comprises a roller bearing disposed at a free end of the rotary arm.

16. A cat toy comprising:
a stationary base having an upwardly extending first wall;
a pivotable track carried by the stationary base having an upwardly extending second wall radially inwardly spaced from the first wall defining a ball rolling channel therebetween; and
a ball received in the ball rolling channel.

17. The cat toy of claim 16 wherein the pivotable track has a track floor extending radially outwardly of the second wall and terminating radially inwardly of the first wall.

18. The cat toy of claim 16 wherein pivotable track comprises a housing in which a rotary drive is disposed that pivots the track relative to the base during rotary drive operation.

19. The cat toy of claim 16 further comprising a pivot disposed between the pivotable track and the stationary base about which the pivotable track pivots when the ball rolls in the ball rolling channel.

20. The cat toy of claim 16 further comprising a rotary drive carried by the pivotable track having an outwardly extending flexible rotary arm resiliently biased against the pivotable track pivoting the pivotable track relative to the stationary base when the flexible rotary arm is rotated causing the ball to roll within the ball rolling channel.

21. A cat toy comprising:
a stationary base;
a pivotable track carried by the stationary base and comprising a ball rolling channel;
a drive carried by the pivotable track comprising an outwardly extending rotary arm rotated by the drive pivoting the pivotable track relative to the stationary base; and
a ball received in the ball rolling channel that rolls when the rotary arm is rotated.
